(19) United States
(12) Patent Application Publication
(10) Pub. No.: US 2013/0328000 A1
(43) Pub. Date: Dec. 12, 2013

(54) CLIP FOR CONNECTING WIRE FENCING TO A FENCE POST

(71) Applicant: RICHARD L. HENDRICKS, Atkinson, NE (US)

(72) Inventor: RICHARD L. HENDRICKS, Atkinson, NE (US)

(21) Appl. No.: 13/493,043

(22) Filed: Jun. 11, 2012

(51) Int. Cl. A01K 3/00; E04H 17/06; E04H 17/04; E04H 17/10

(52) U.S. Cl. 256/10; 256/47; 256/46

(57) ABSTRACT

A clip for connecting a strand of wire fencing to a line post of a fence is disclosed. The clip includes an aperture for receiving the wire to facilitate movement of the wire when the clip is coupled to the line post.

### BACKGROUND

Wire type fences are utilized in the agricultural industry for separating property lines and for maintaining livestock. Current wire fencing systems can lack in durability and functionality, be difficult to repair, and suffer from several performance issues.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner.

Aspects of the disclosure pertain to a clip for connecting wire fencing to a line post of a fence. The clip includes an aperture for receiving the wire to facilitate movement of the wire when the clip is coupled to the line post.

### BRIEF DESCRIPTION OF THE DRAWINGS

FIG. 1 is an example perspective view of an example fence clip;

FIG. 2 is an example side plan view of the example fence clip shown in FIG. 1;

FIG. 3 is an example bottom plan view of the example fence clip shown in FIG. 1;

FIG. 4 is an example top plan view of the example fence clip shown in FIG. 1 and an example top plan view of an example fence post;

FIG. 5 is an example top plan view of the example fence clip shown in FIG. 4 secured to an example fence post;

FIG. 6 is an example perspective view of the example fence clip shown in FIG. 5;

FIG. 7 is an example perspective view of the example fence clip and the example fence post shown in FIG. 5, which further depicts a section of example wire;

FIG. 8 is an example front plan view of the example fence clip, the example fence post and the section of example wire shown in FIG. 7;

FIG. 9 is an example top plan view of the example fence clip, the example fence post and the example section of example wire shown in FIG. 7;

FIG. 10 is an example side plan view of the example fence clip, the example fence post and section of example wire shown in FIG. 7;

FIG. 11 is an example perspective view illustrating multiple example fence posts; and

FIG. 12 is an example perspective view of the example fence clip shown in FIG. 1 with example wire.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

Wire fences of all types are utilized in the agricultural industry. A few examples of wire fences include barbed wire fences and electric wire fences. In agricultural settings, wire fencing, due to its relatively low expense and its relatively high strength and restraining properties, is often used for constructing fences for containing animals (ex.—cattle) within large areas (ex.—pastures). Further, compared to other fencing options, wire fences are relatively easy to construct, while requiring a minimal amount of equipment (ex.—fence posts, wire, wire fasteners, fence staples).

In a typical constructed wire fence, multiple (ex.—4 to 7) strands of wire can be aligned under tension between heavy braced fence posts (ex.—end posts, corner posts or strainer posts). Further, the strands of wire can be held at or near a desired height along the entire span (ex.—from end post-to-end post) of the fence by being attached to a series of line posts which are located between and generally co-linear with the end posts. For example, the strands can be spaced apart from each other such that the top strand of the wire fence is held at or near a height which is proximal to the upper (ex.—top) ends of the fence posts along the entire span of the fence, while the bottom strand of the wire fence is held at a height which is proximal to the ground level along the entire span of the fence, thereby allowing the multiple strands to cover the vertical area extending from the tops of the posts to the ground level. Currently, wire fasteners are used to tightly secure the wire between the wire fastener and the line posts (ex.—metal T-posts) in such a manner so as to: a.) maintain each wire at its correct height along the entire span of the fence; and b.) restrict movement of each strand (ex.—vertical and/or horizontal movement).

Over time, one or more of the strands of wire can begin to sag in some places (ex.—sections) along the fence, thereby providing an indication that the tension on that particular strand of wire has to be adjusted (ex.—tightened) in order to re-position the strand to its correct height relative to the fence posts. In other instances, breaks in the wire can occur at points where the wire fastener secures the wire to the line posts. Due to the movement restraint of the wire caused by currently available wire fasteners, the wire fasteners typically need to be removed before the strand of wire can be repaired, moved and/or tightened (ex.—before the tension upon the strand of wire can be increased). For example, currently available wire fasteners do not provide clearance between the line post and the fastener to allow for the strand of wire to freely move along the fence line (ex.—towards one of the end posts) to allow for proper height adjustment and/or tightening of the wire. As such, when a force is applied to the wire, the wire is restricted from movement and held fast to the post by the fastener. Further, currently available wire fasteners, in order to limit the inward/outward movement of the strands, can be connected to the line posts in such a manner so as to pin or trap the wire against the line posts. This can result in accelerated rusting of the wire (since moisture tends to collect at or near these contact points between the wire and the fastener) resulting in a shortened life span for the wire. Further, because the currently available wire fasteners are designed to tightly pinch the wire between the fastener and the line post, the currently available wire fasteners can cause the wire to degrade or weaken at the contact point (ex.—pressure point), thereby shortening the life span of the wire fencing.

As more fully set forth below, aspects of the disclosure include a fence clip that includes an aperture for receiving the strand of wire to facilitate movement of the wire when the clip is coupled to the line post. The fence clip and the aperture associated with the fence clip facilitates a separation between the wire and the post which allows some inward and outward movement of the strand of wire relative to the fenced-in area (ex.—movement towards and away from the post) and parallel to the ground, thereby providing some spring-like flexibility to the fence along the entire span of the fence (ex.—from end post-to-end post), while promoting the avoidance of the wire degradation and rusting issues associated with currently available wire fasteners. The fence clip and the aperture of the fence clip also provide sufficient space to allow for omni-directional movement (ex.—up-and-down movement, side-to-side movement, and movement along the fence line/towards the end posts) of the strand of wire, thereby allowing for the wire to be moved, repaired and/or tightened (ex.—stretched or pulled towards one of the end posts of the fence to take slack out of the wire so that the wire can be positioned and/or re-positioned at the desired height without having to loosen or detach the clip from the line post. The fence clip and the aperture of the fence clip also promote the ability to maintain a strand of wire at or near a desired height and/or distance relative to a fence post (ex.—a line post), the ground and/or other strands of wire of the fence. Furthermore, the fence clip and the aperture of the fence clip can be configured for use with several types of wire fences. For example, the size of the aperture can be configured to allow clearance for barbs of a barb wire fence. Also, one or more portions of the fence clip and/or aperture of the fence clip can be coated with an electrical insulating material to reduce the likelihood of shorts with an electrical fence. Moreover, the aperture can be configured to receive an electrical insulating member such as an insulated insert to reduce shorting with electrical fences.

The fence clip is described below using terminology that identifies elements of the fence clip. The identification of the elements is not meant to limit the construction of the fence clip to individual elements being coupled together. Although a fence clip having individual elements coupled together is contemplated, the fence clip can be formed of a solid uniform construction such as a molded metal member, a bent metal wire, a molded plastic member, a bent plastic member, a molded composite member, and/or a bent composite member.

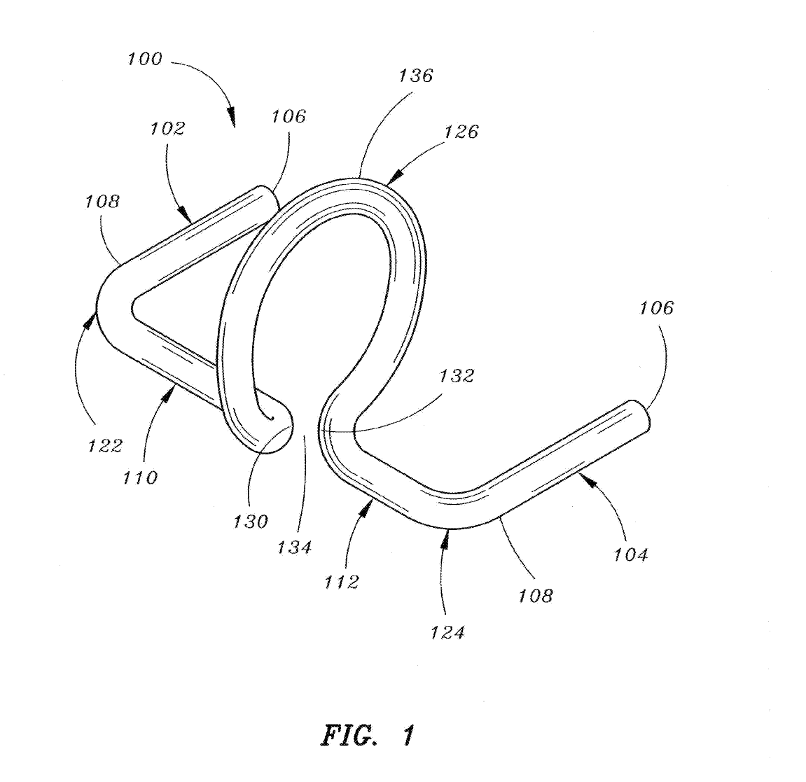

As indicated in FIGS. 1-3, the fence clip 100 can include one or more securing arms. For example, the fence clip 100 can include a first securing arm 102 and/or a second securing arm 104. Each securing arm (102, 104) can include a first end 106 and a second end 108. As indicated in FIG. 1, the second end 108 may not be a true end but may be the end of the securing arm portion of fence clip 100 for purposes of describing elements of a continuous structure. The first ends 106 of the securing arms (102, 104) can be spaced apart from each other by a distance D2, as shown in FIG. 3. In one aspect, first securing arm 102 can be generally parallel to second securing arm 104. Yet, as more fully set forth below, first securing arm 102 and second securing arm 104 may not be parallel to one another.

The fence clip 100 can further include a plurality of stabilizing bars. For example, the fence clip 100 can include a first stabilizing bar 110 and a second stabilizing bar 112. Each stabilizing bar (110, 112) can include a first end 114 and a second end 116. Similar to the first and second securing arms (102, 104), the first end 114 and the second end 116 may not be true ends but may be the end of the stabilizing bar portion of the fence clip 100 for purposes of the describing elements of a continuous structure. Further, each stabilizing bar (110, 112) can include a first side (ex.—an inner side) 118 and a second side (ex.—an outer side) 120 can located generally opposite the first side 118. In the example orientation indicated in FIG. 1, first stabilizing bar 110 can be generally parallel to second stabilizing bar 112. In another example, first stabilizing bar 110 can be generally perpendicular to first securing arm 102 and second stabilizing bar 112 can be generally perpendicular to second securing arm 104. In another example, first stabilizing bar 110 and first securing arm 104 can generally reside in the same horizontal plane. In yet another example, second stabilizing bar 112 and second securing arm 104 can generally reside in the same horizontal plane. In still another example, first stabilizing bar 110, second stabilizing bar 112, first securing arm 102 and second securing arm 104 can generally reside in the same horizontal plane.

The first stabilizing bar 110 and the second stabilizing bar 112 can have other orientations depending on the tool utilized for securing fence clip 100 to the fence post. For example, one common tool for securing fence clips to a fence post is a 440 T-post gripper manufactured by Dutton-Lainson Company of Hastings, Neb. Such tools have top and bottom positioning brackets to hold the fence clip during positioning and crimping. Accordingly, first stabilizing bar 110 and second stabilizing bar 112 can be configured in relation to their respective first securing arm 102 and second securing arm 104 so that the first end 130 and second end 132 are vertically offset (e.g. not within the same horizontal plane) with respect to the first joint 122 and second joint 124. The vertical offset can allow the helical member 126 to clear the one or more of the positioning brackets of the tool (such as the indicated T-post gripper). To provide the vertical offset, the first stabilizing bar 110 can be linear and slant between the first joint 122 and the first end 130. Likewise, the second stabilizing bar 112 can be linear and slant between the second joint 124 and the second end 132. Providing a slant is just one way of providing clearance for a crimping tool. First stabilizing bar 110 and second stabilizing bar 112 can also be non-linear to provide the vertical offset.

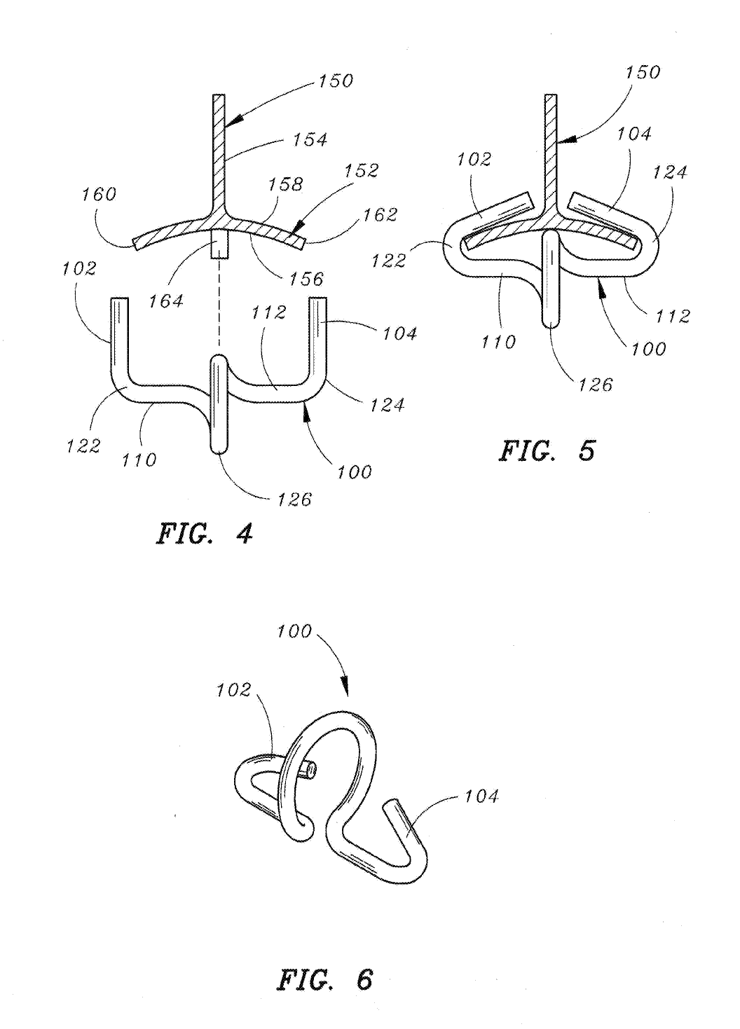

The fence clip 100 can further include one or more joints. For example, the second end 108 of the first securing arm 102 can be coupled to the first end 114 of the first stabilizing bar 110 by a first joint 122, while the second end 108 of the second securing arm 104 is coupled to the first end 114 of the second stabilizing bar 112 by a second joint 124. The joints (122, 124) can be malleable joints, hinge joints, snapping joints, locking joints, mechanical joints, magnetic joints and combinations thereof. Joints (122, 124) can facilitate hinged movement between stabilizing bars (110, 112) and a respective securing arm (102, 104). As an example, the first securing arm 102 can be rotated about joint 122 and relative to stabilizing bar 110. The rotation can occur from an open angle to a closed angle. For example, FIG. 4 generally depicts fence clip 100 in an open position. The open angle between the securing arm 102 and stabilizing bar 110 is about 90° in FIG. 4. Yet the open angle can be between about 45° to about 225° For example, the angle can be about 45°, 50°, 55°, 60°, 65°, 70°, 75°, 80°, 85°, 90°, 95°, 100°, 105°, 110°, 115°, 120°, 125°, 130°, 135°, 140°, 145°, 150°, 155°, 160°, 165°, 170°, 175°, 180°, 185°, 190°, 195°, 200°, 205°, 210°, 215°, 220°, 225° to about 45°, 50°, 55°, 60°, 65°, 70°, 75°, 80°, 85°, 90°, 95°, 100°, 105°, 110°, 115°, 120°, 125°, 130°, 135°, 140°, 145°, 150°, 155°, 160°, 165°, 170°, 175°, 180°, 185°, 190°, 195°, 200°, 205°, 210°, 215°, 220°, 225°. FIG. 5 generally depicts fence clip 100 in a closed position. The closed angle can be between about 45° to about 0° For example, the closed angle between the first securing arm 102 and the first stabilizing bar 110 can be about 0°, 5°, 10°, 15°, 20°, 25°, 30°, 35°, 40°, 45° to about 0°, 5°, 10°, 15°, 20°, 25°, 30°, 35°, 40°, 45°. The open angle and the closed angle formed by the second securing arm 104 and the second stabilizing bar 112 can include similar angles as indicated above.

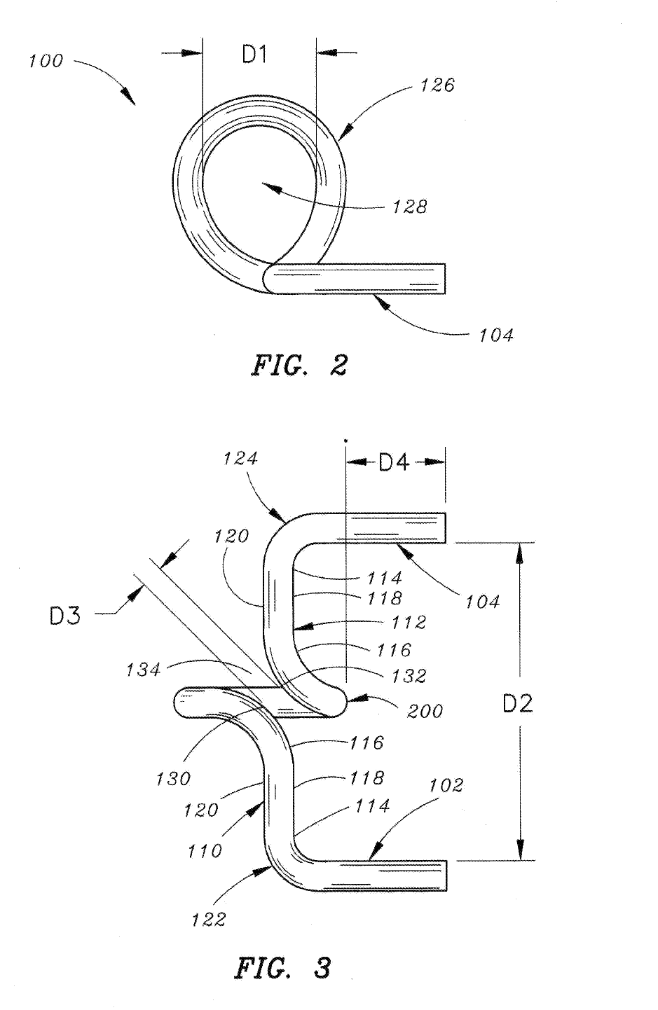

The fence clip 100 can further include an aperture 128 defined by a helical member 126. The term “helical member” as used herein can include a generally smooth spiral helix as indicated in the figures. The term “helical member” can also encompass a helical member that includes linear portions. For example, helical member 126 can include a triangular shaped helix, a square shaped helix, a pentagram shaped helix and the like. The term “helical member” can include a helical member that is formed continuous with the other members of the clip as depicted in the figures. Yet, the term “helical member” also includes a separate helical member that is not continuous. For example, the fence clip can include a single stabilizing bar that connects joints 122 and 124. The helical member 126 can include a separate helical member that has an opening and is connected to the single stabilizing bar between joints 122 and 124. In such a situation, the term “helical member” can encompass a ring shaped member, a triangular shaped member, a square shaped member, a pentagram shaped member and the like. The aperture 128 can have a distance D1 (as shown in FIG. 2). The distance D1 of the aperture 128 can also be an inner distance of the helical member 126. Distance D1 can be a diameter in the situation where the helix member is a spiral type helix or ring shaped member. In other situations, the distance D1 can be the greatest opening distance formed by the aperture defined by the helical member. For example, D1 can be from about 0.1 inches to about 2.00 inches. For example, D1 can be about 0.1, 0.2, 0.3, 0.4, 0.5, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00, 1.25, 1.50, 1.75, 2.0 inches to about 0.1, 0.2, 0.3, 0.4, 0.5, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00, 1.25, 1.50, 1.75, 2.0 inches. Further, helical member 126 can include a first end 130 and a second end 132. As indicated in FIG. 1, the first end 130 and the second end 132 may not be a true end but may be the end of the helical structure portion of fence clip 100 for purposes of the describing elements of a continuous structure. The first end 130 of the helical structure 126 can be coupled to or continuous with the second end 116 of the first stabilizing bar 110. The second end 132 of the helical member 126 can be connected to or continuous with the second end 116 of the second stabilizing bar 112. The second end 132 of the helical member 126 can be spaced apart from the first end 130 of the helical member 126 by a distance, D3, as shown in FIG. 3, to form an aperture opening 134. For instance, distance D3 (ex.—the width of the aperture opening 134) can be from about 0.05 inches to about 1.00 inches. For example, D3 can be about 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00 inches to about 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00 inches. Other values for the aperture opening are contemplated depending on the thickness of the wire that is fitted through the aperture opening 134. The aperture opening 134 can be formed generally opposite an apex (ex.—a highest vertical point) 136 of the helical member 126.

As an example related to the orientation depicted in FIG. 1, the helical member 126 can reside in a generally vertical plane. The vertical plane where the helical member 126 resides can be generally perpendicular to the horizontal plane where the first locking arm 102 resides. In other aspects, the vertical plane where the helical member 126 resides can be generally perpendicular to the horizontal plane where the second locking arm 104 resides . In other aspects, when in an upright position (e.g. FIG. 1) the first end 130 and the second end 130 are vertically offset from a horizontal plane where the first joint 122 and the second joint 124 reside.

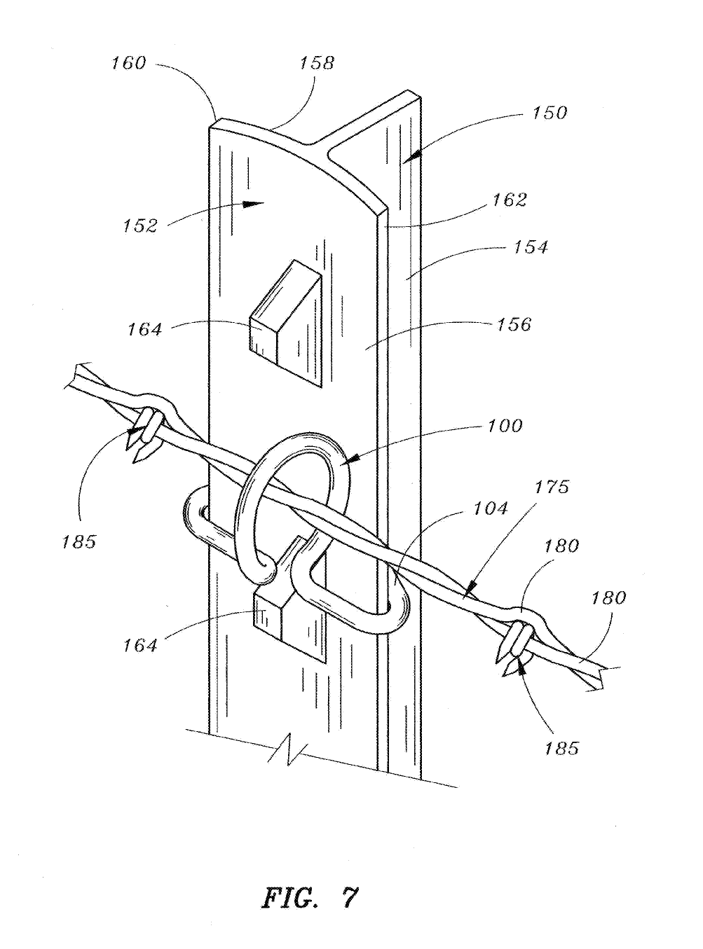

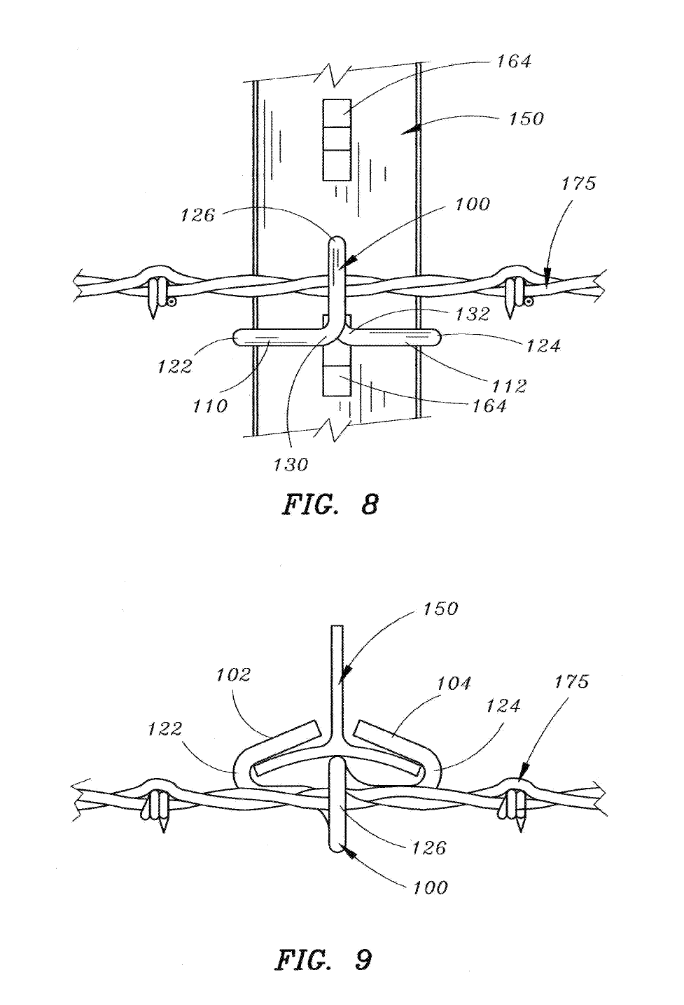

Referring generally to FIGS. 4-12, the fence clip 100 can be configured for being connected to (ex.—secured to) a fence post (ex.—a line post or a metal T-post located between two end posts of a span of fence) 150 of a wire (ex.—barbed wire, unbarbed wire, electrical wire) fence and can further be configured for connecting (ex.—securing) wire 175 of the fence to the line post 150. As mentioned above, one type of line post to which the fence clip 100 can be connected can be a T-post (ex.—metal T-post) 150. The fence clip 100 can also be configured for being connected to various other types and/or shapes of fence post. However, the discussion provided herein is directed towards the fence clip 100 being secured to a T-post 150. As shown in FIG. 7, the T-post 150 is a formed as a longitudinally-extended T-shaped cross-section including a first wall 152 and a second wall 154. The second wall 154 can be generally perpendicular to the first wall 152. The first wall 152 can include a first face (ex.—front face) 156, a second face (ex.—rear face) 158, located generally opposite the first face 156, and side edges (160, 162) extending between and connected to the faces (156, 158). The front face 156 can further have one or more protrusions 164 formed upon its surface.

The fence clip 100 can be secured to the T-post 150 by aligning the clip 100 relative to the post 150 (as shown in FIG. 4) so that the first wall 152 of the T-post 150 is received between the securing arms (102, 104) of the clip 100. The clip 100 can be constructed and/or can be configurable so that the distance D2 (shown in FIG. 3) separating the securing arms (102, 104) is sufficiently wide for simultaneously receiving the first wall 152 and side edges (160, 162) of the T-post 150 as shown in FIG. 4. For example, the distance D2 separating the securing arms (102, 104) can be from about 0.5 inches to about 5.0 inches. For example, D2 can be about 0.50, 0.75, 1.00, 1.25, 1.50, 1.75, 2.00, 2.25, 2.50, 2.75, 3.00, 3.25, 3.50, 3.75, 4.00, 4.25, 4.50, 4.75, 5.00 inches to about 0.50, 0.75, 1.00, 1.25, 1.50, 1.75, 2.00, 2.25, 2.50, 2.75, 3.00, 3.25, 3.50, 3.75, 4.00, 4.25, 4.50, 4.75, 5.00 inches. The clip 100 can be directed against the front face 156 of the first wall 152 of the T-post 150, such that one or more of the helical member 126, the joints (122, 124) and the stabilizing bars (110, 112) are engaged against (ex.—at least partially contacting) the front face 156 of the first wall 152 of the T-post 150. When the clip 100 is engaged against the front face 156 of the first wall 152 of the post 150 as described above, the securing arms (102, 104) of the clip 100 are of a sufficient length to extend past the first wall 152 of the post 150. For example, the arms (102, 104) can be from about 0.25 inches to about 2.0 inches. For example the length can be about 0.25, 0.50, 0.75, 1.00, 1.25, 1.50, 1.75, 2.00 inches to about 0.25, 0.50, 0.75, 1.00, 1.25, 1.50, 1.75, 2.00 inches Further, when the clip 100 is engaged against the front face 156 of the first wall 152 of the post 150 as described above, a distance (“D4” as shown in FIG. 2) between the ends (106, 108) of the securing arms (102, 104) and a surface (ex.—a surface on the helical member 126) 200 of the clip 100 that engages the front face 156 is also a sufficient distance to allow the arms (102, 104) to extend past the first wall 152 of the post 150. For example, distance D4 can be from about 0.25 inches to about 2.00 inches. Distance D4 can be from about 0.25, 0.50, 0.75, 1.00, 1.25, 1.50, 1.75, 2.00 inches to about 0.25, 0.50, 0.75, 1.00, 1.25, 1.50, 1.75, 2.00 inches.

Furthermore, when the clip 100 is engaged against the front face 156 of the first wall 152 of the post 150 as described above, the securing arms (102, 104) of the clip 100 can be rotated (ex.—bent, moved, incrementally adjusted, crimped) about the joints (122, 124) toward both the stabilizing bars (110, 112) and the rear face 158 of the first wall 152 of the post 150. For example, a hand-held mechanical crimping tool can be used to crimp the arms of the clip 100 into the crimped position (the crimped position of the clip 100 being shown in FIGS. 5 and 6). The above-referenced rotating of the arms (102, 104) of the clip 100 can cause the clip 100 to conform to (ex.—tighten around) the post 150, as shown in FIG. 5, such that the joints (122, 124) wrap around the side edges (160, 162) of the first wall 152 of the post 150; the securing arms (102, 104) are directed against (ex.—are at least partially in contact with) the rear face 158 of the first wall 152 of the post 150 and; one of the helical member 126, the first stabilizing bar 110, and the second stabilizing bar 112 are at least partially engaged against the front face 156 of the first wall 152 of the post 150.

Configuring the clip 100 around the post 150, as shown in FIG. 5, results in a tension fit between the clip 100 and the post 150 via which the clip 100 is tightly secured to the post 150 at a sufficient tension that the clip 100 resists movement (ex.—sliding) relative to the post 150. The clip 100 can be formed of a material which is of a gauge or strength that it is strong (ex.—sturdy) enough to provide the above-described secure, tension fit against the post 150, while still being malleable. For instance, the clip 100 can be formed of metal wire, such as galvanized steel or American Wire Gauge (AWG) number “9” wire. It is contemplated that the clip 100 can be at least partially formed of other materials, such as plastic, rubber, a composite, or the like.

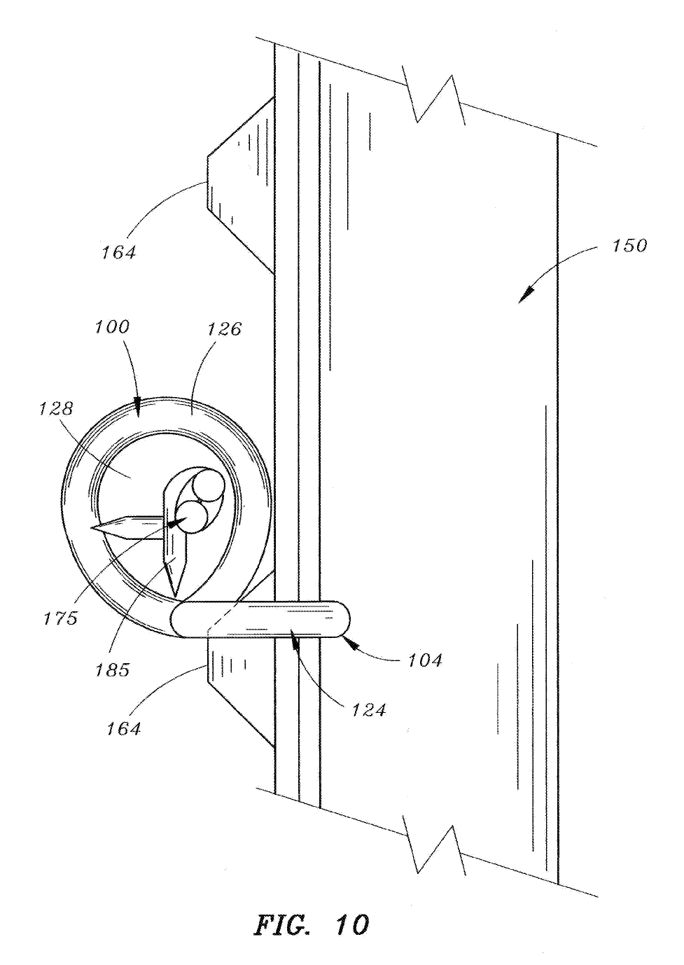

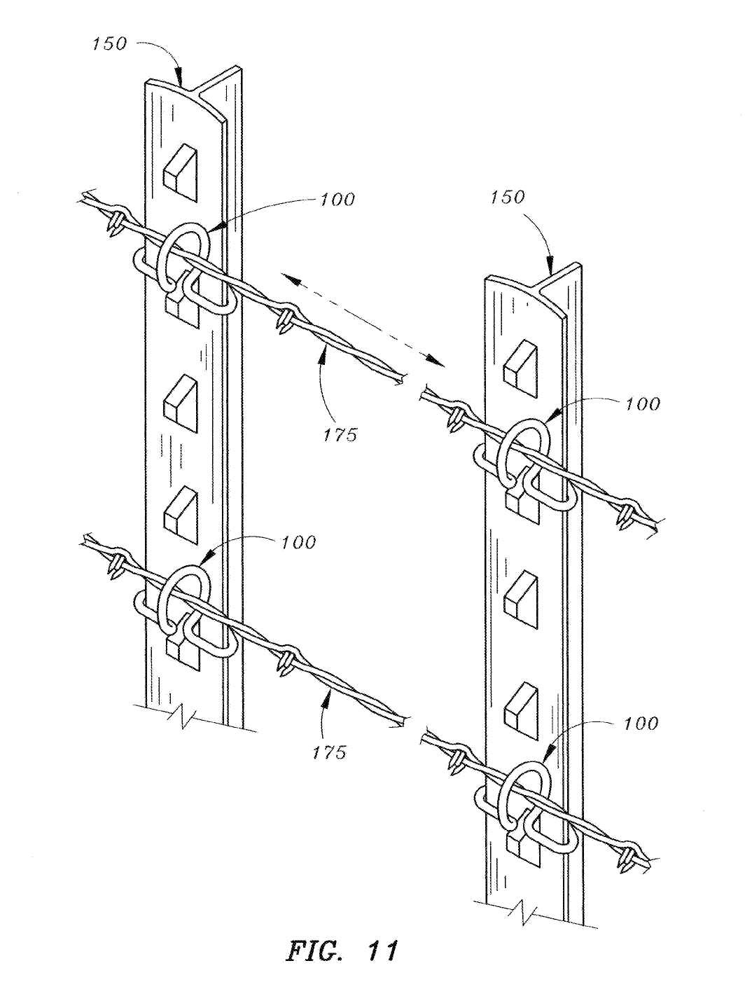

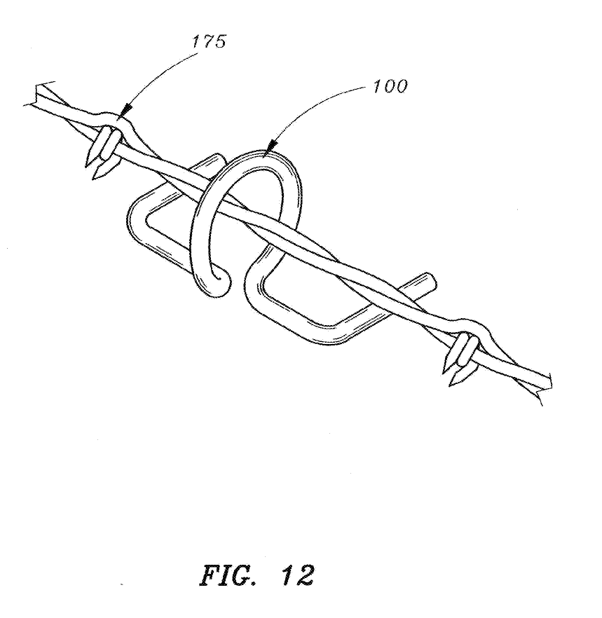

Referring generally to FIGS. 7-12, the fence clip 100 can be secured to a post 150 at a pre-determined height along the post for connecting a strand of wire 175 to the post and for promoting the ability to maintain the strand of wire 175 at or near the pre-determined height along the post 150. As an example, prior to or after securing the clip 100 to the post 150 (as described above and shown in FIG. 5), the clip 100 can be aligned relative to a strand of wire 175 (as shown in FIG. 12), such that strand of wire 175 is received within the aperture 128 formed by the helical member 126. The aperture opening 134 separating the first and second ends (130, 132) of the helical member 126 allows for introduction of the wire 175 into the aperture 128 formed by the helical member 126. The aperture 128 can be sufficiently sized to allow for both the sub-strands 180 of the wire 175 and the barbs 185 (in the situation where the wire is a barbed wire) of the wire 175 to be directed through the aperture 128 (as shown in FIGS. 10 and 11), such as when stretching the wire 175 along the fence line (ex.—towards an end post of the fence). Further, the aperture 128 can also be sufficiently sized to allow for at least some inward-outward movement of the strand of wire 175 relative to an area which is fenced in by the wire (and parallel to the ground). This allows for the structural integrity of the fence and the wire 175 to be maintained when livestock bumps up against the strands of wire 175 of the completed fence, such that the clip 100 allows for a spring-like action along the entire span of the fence.

In other examples, the wire fencing 175 can be electric fencing. When the wire fencing 175 is electric fencing, at least a portion of the clip 100 (ex.—the helical member 126) can be formed with, connected to and/or coated with a non-conductive (ex.—insulating) material, such as plastic, for preventing the wire fencing 175 from contacting other metal components of the fence (ex.—metal portions of the clip 100) and thereby preventing the electric fencing from shorting out (ex.—grounding out).

After the wire 175 is located within the aperture 128 defined by the helical member 126, the clip 100 can then be secured to the post 150 (as discussed above), thereby allowing the clip 100 to promote the ability to maintain the strand of wire 175 at a desired height relative to the line post 150, relative to the ground within which the line post 150 is secured and relative to other strands of wire of the fence.

Further, after the wire 175 is located within the aperture 128 defined by the helical member 126 and after the clip 100 is secured to the post 150 (as discussed above), the clip 100 indirectly (ex.—loosely) connects/secures the strand of wire 175 to the post 150, such that the wire 175 is spaced apart from (ex.—not pinned against) the post 150. The clip 100 achieves this via the helical member 126, a portion of which separates the wire 175 from the post 150, such that the portion of the helical member 126 forms a physical barrier (is located) between the wire 175 positioned within the aperture 128 and the post 150. Such a configuration allows for some inward and outward movement of the strand of wire 175 relative to the fenced-in area (ex.—movement towards and away from the post 150 and the fenced-in area) and parallel to the ground. By providing for such inward-outward movement, the clip 100 allows the constructed fence to have some spring-like flexibility along the entire span (ex.—from end post-to-end post) of the fence when livestock bumps up against the wire 175 of the fence. As mentioned above, currently available wire fasteners pin the wire directly against the fence post, causing problems such as rusting of the wire (due to moisture gathering in the area at or near the contact point) and degradation of the barbed wire (due to the pinching of the wire between the fastener and the post), events which tend to shorten the life span of the barbed wire. By securing (ex.—indirectly securing, loosely securing) the wire 175 to the post 150 in a manner such that the wire 175 is spaced apart (ex.—distanced, separated) from the post 150, the clip 100 promotes avoidance of the above-referenced wire rusting and wire degradation issues associated with the currently available wire fasteners.

Still further, after the wire 175 is located (ex.—positioned) within the aperture 128 defined by the helical member 126 and after the clip 100 is secured to the post 150 (as discussed above), the clip 100 provides sufficient space, via the aperture 128, to allow for omni-directional movement (ex—side-to-side movement within the aperture, up-and-down movement within the aperture, and end post-to-end post movement through and beyond the aperture) of the strand of wire, thereby allowing for the wire to be moved, repaired and/or tightened (ex.—stretched or pulled towards one of the end posts of the fence to take slack out of the wire 175) so that the wire 175 can be positioned and/or re-positioned at the desired height (as shown in FIG. 11) without having to loosen or detach the clip 100 from the line post 150. The ability to move and/or manipulate the wire 175 without having to remove or loosen the clip 100 also promotes ease of repair of the wire fencing 175. Unlike currently available wire fasteners, the clip 100 facilitates stretching of the barbed wire along the fence line from a first line post to a second line post, and further, such that the clearance 128 can allow for a barb 185 located on a strand of wire 175 being stretched generally along the fence line to be moved through the helical members 126 of multiple clips 100 located on multiple corresponding line posts 150 along the span of the fence.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A clip for connecting wire fencing to a fence post, the clip comprising:
a first securing arm;
a second securing arm;
at least one stabilizing bar, wherein the at least one stabilizing bar is coupled to the first securing arm by a first joint and to the second securing arm by a second joint;
a helical member connected to the at least one stabilizing bar between the first and second joint, wherein the helical member defines an aperture; and
an aperture opening at least partially formed by the helical member for providing access to the aperture.

2. The clip of claim 1, wherein at least a portion of the helical member is associated with an electrical insulation.

3. The clip of claim 1, wherein the first securing arm, the second securing arm, the first joint, the second joint, and the at least one stabilizing bar are of single unitary construction.

4. The clip of claim 3, wherein the helical member is fixedly attached to the stabilizing bar.

5. The clip of claim 1, wherein the helical member is at least one member of a group consisting of: a ring shaped member, a triangular shaped member, a square shaped member, and a pentagon shaped member.

6. The clip of claim 1, wherein the helical member resides in a plane that is generally perpendicular to a plane where the first securing arm, and the second securing arm reside.

7. The clip of claim 1, wherein the at least one stabilizing bar includes a first stabilizing bar and a second stabilizing bar, wherein the first stabilizing bar is coupled to the first securing arm by a first joint, wherein the second stabilizing bar is coupled to the second securing arm by a second joint.

8. The clip of claim 7, wherein the first securing arm, the second securing arm, the first joint, the second joint, the first stabilizing bar, the second stabilizing bar, and the helical member are of single unitary construction.

9. The clip of claim 7, wherein the helical member is at least one member of a group consisting of: a spiral helix, a triangular shaped helix, a square shaped helix and a pentagram shaped helix.

10. A clip for connecting wire fencing to a fence post, the clip comprising:
a first securing arm;
a second securing arm;
a first stabilizing bar coupled to the first securing arm by a first joint;
a second stabilizing bar coupled to the second arm by a second joint;
a helical member having a first end connected to the first stabilizing and a second end connected to the second stabilizing bar, wherein the helical member defines an aperture; and
an aperture opening formed by a gap between the first end of the helical member and the second end of the helical member.

11. The clip of claim 10, wherein at least a portion of the helical member is electrically insulated.

12. The clip of claim 10, wherein the helical member resides in a plane that is generally perpendicular to a plane where the first securing arm and the second securing arm reside.

13. The clip of claim 12, wherein a first end of the helical member and a second end of the helical member are vertically offset from a horizontal plane where the first and second joint reside.

14. The clip of claim 10, wherein the first securing arm, the second securing arm, the first joint, the second joint, the first stabilizing bar, the second stabilizing bar, and the helical member are of single unitary construction.

15. The clip of claim 10, wherein the helical member is at least one member of a group consisting of: a spiral helix, a triangular shaped helix, a square shaped helix and a pentagram shaped helix.

16. A wire fencing system, the wire fencing system comprising:
at least one fence post having a wall portion with a front surface and a rear surface;
at least one wire;
at least one clip coupling the at least one wire to the at least one fence post, wherein the at least one clip includes:
a first securing arm juxtaposed at least a portion of the rear surface of the wall portion;
a second securing arm juxtaposed at least a portion of the rear surface of the wall portion;
at least one stabilizing bar juxtaposed the front surface of the wall portion;
a helical member connected to the at least one stabilizing bar, wherein the helical member defines an aperture where the wire extends therethrough; and
an aperture opening at least partially formed by the helical member for removably receiving the wire within the aperture.

17. The wire fencing system of claim 16, wherein a portion of the helical member at least partially separates the at least one wire from the front surface of the at least one fence post.

18. The wire fencing system of claim 16, wherein the wire is barbed wire, wherein a dimension of the aperture provides clearance to facilitate lateral movement of the barbed wire.

19. The wire fencing system of claim 16, wherein the wire is electrical wire, wherein at least a portion of the helical member is electrically insulated.

20. The wire fencing system of claim 16, wherein the clip is of single unitary construction.
